(19) United States
(12) Patent Application Publication
(10) Pub. No.: US 2022/0188144 A1
(43) Pub. Date: Jun. 16, 2022

(54) Intra-Process Caching and Reuse of Threads

(71) Applicant: Oracle International Corporation, Redwood City, CA (US)

(72) Inventors: David Dice, Burlington, MA (US); Alex Kogan, Burlington, MA (US)

(21) Appl. No.: 17/119,998

(22) Filed: Dec. 11, 2020

(51) Int. Cl. G06F 9/48

(52) U.S. Cl. CPC G06F 9/4843

(57) ABSTRACT

A computer comprising one or more processors and memory implements a thread manager for multiple threads of an application. The thread manager may implement a process-local cache of standby threads for the application. Upon request to create a thread for the application, the thread manager may use a standby thread from the process-local cache to create the requested thread, initializing thread-local storage elements and scheduling the thread for execution. Upon request to terminate a thread of the application, the thread manager may place the thread in an unscheduled state and add the thread to the process-local cache of standby threads. The thread manager may also add or remove standby threads to the process-local cache of standby threads in the event the thread manager determines that the number of standby threads in the process-local cache lies outside a target range.

### BACKGROUND

### Field of the Disclosure

This disclosure relates generally to computer software, and more particularly to systems and methods for caching and reusing threads in a multi-threaded execution environment.

### Description of the Related Art

Modern computer systems conventionally include the ability to execute applications that include multiple threads that may execute simultaneously. While some applications may statically allocate a set of executing threads, it is common for applications to dynamically create and destroy threads as processing demands. This thread creation and destruction, however, requires significant processing time and additionally requires memory allocation operations in both application and operating system kernel memory. Therefore, dynamic thread management may introduce significant latencies, leading to scalability problems as concurrency is increased and giving rise to a need to manage thread creation and destruction efficiently. What is needed are techniques that mitigate these creation and destruction latencies to improve scalability in these applications.

### SUMMARY

Methods, techniques and systems for providing a thread cache are described. A computer may implement a thread manager including a process-local cache of standby threads for an application. Upon request to create a thread for the application, the thread manager may select a standby thread from the process-local cache to create the requested thread, initialize thread-local storage elements for the selected thread and schedule the thread for execution. Upon request to terminate a thread of the application, the thread manager may place the thread in an unscheduled state and add the thread to the process-local cache of standby threads. The thread manager may also add and remove standby threads to the process-local cache of standby threads in the event the thread manager determines that the number of standby threads in the process-local cache is lies outside a range defined my upper and lower thresholds.

### BRIEF DESCRIPTION OF THE DRAWINGS

FIG. 1 is a block diagram illustrating a system implementing a thread manager providing a thread cache for an application in various embodiments.

FIG. 2 is a flow diagram illustrating an embodiment of a method of creating thread for an application using a standby thread from a thread cache.

FIG. 3 is a flow diagram illustrating another embodiment of a method of creating thread for an application using a standby thread from a thread cache.

FIG. 4 is a flow diagram illustrating an embodiment of a method for managing standby threads to a thread cache.

FIG. 5 is a flow diagram illustrating one embodiment of a method for terminating a thread using a thread cache.

FIG. 6 is a flow diagram illustrating a series of interactions between an application, a thread manager implementing a thread cache, and an operating system kernel, in various embodiments.

FIG. 7 is a block diagram illustrating one embodiment of a computing system that is configured to implement a thread manager providing a thread cache, as described herein.

While the disclosure is described herein by way of example for several embodiments and illustrative drawings, those skilled in the art will recognize that the disclosure is not limited to embodiments or drawings described. It should be understood that the drawings and detailed description hereto are not intended to limit the disclosure to the particular form disclosed, but on the contrary, the disclosure is to cover all modifications, equivalents and alternatives falling within the spirit and scope as defined by the appended claims. Any headings used herein are for organizational purposes only and are not meant to limit the scope of the description or the claims. As used herein, the word “may” is used in a permissive sense (i.e., meaning having the potential to) rather than the mandatory sense (i.e. meaning must). Similarly, the words “include”, “including”, and “includes” mean including, but not limited to.

Various units, circuits, or other components may be described as “configured to” perform a task or tasks. In such contexts, “configured to” is a broad recitation of structure generally meaning “having circuitry that” performs the task or tasks during operation. As such, the unit/circuit/component can be configured to perform the task even when the unit/circuit/component is not currently on. In general, the circuitry that forms the structure corresponding to “configured to” may include hardware circuits. Similarly, various units/circuits/components may be described as performing a task or tasks, for convenience in the description. Such descriptions should be interpreted as including the phrase “configured to.” Reciting a unit/circuit/component that is configured to perform one or more tasks is expressly intended not to invoke 35 U.S.C. § 112(f) interpretation for that unit/circuit/component.

This specification includes references to “one embodiment” or “an embodiment.” The appearances of the phrases “in one embodiment” or “in an embodiment” do not necessarily refer to the same embodiment, although embodiments that include any combination of the features are generally contemplated, unless expressly disclaimed herein. Particular features, structures, or characteristics may be combined in any suitable manner consistent with this disclosure.

### DETAILED DESCRIPTION OF EMBODIMENTS

Modern computer systems conventionally include the ability to execute applications that include multiple threads that may execute simultaneously. While some applications may statically allocate a set of executing threads, it is common for applications to dynamically create and destroy threads as processing demands. Creating and destroying threads, however, may incur significant processing time leading to high latency, even absent concurrency, and scalability problems as concurrency increases. To address these performance issues, a process-local cache of threads may be used. Specifically, instead of destroying terminated threads, the terminated threads may be cached for reuse in the context of subsequent thread creation requests. With caching, the cost of creating a new thread may drop as much as an order of magnitude over conventional approaches.

To mitigate the costs of thread creation and destruction, methods, techniques and systems for providing a thread cache are described below. A computer may implement a thread manager including a process-local cache of standby threads for an application. Upon request to create a thread for the application, the thread manager may select a standby thread from the process-local cache that maintains standby threads to create the requested thread, initialize thread-local storage elements for the selected thread and schedule the thread for execution. Upon request to terminate a thread of the application, the thread manager may place the thread in an unscheduled state and add the thread to the process-local cache of standby threads. The thread manager may also add and remove standby threads to the process-local cache of standby threads in the event the thread manager determines that the number of standby threads in the process-local cache lies outside a range defined my upper and lower thresholds. Threads that have logically terminated are thus retained for subsequent reuse, sparing the cost of creating new threads in the future.

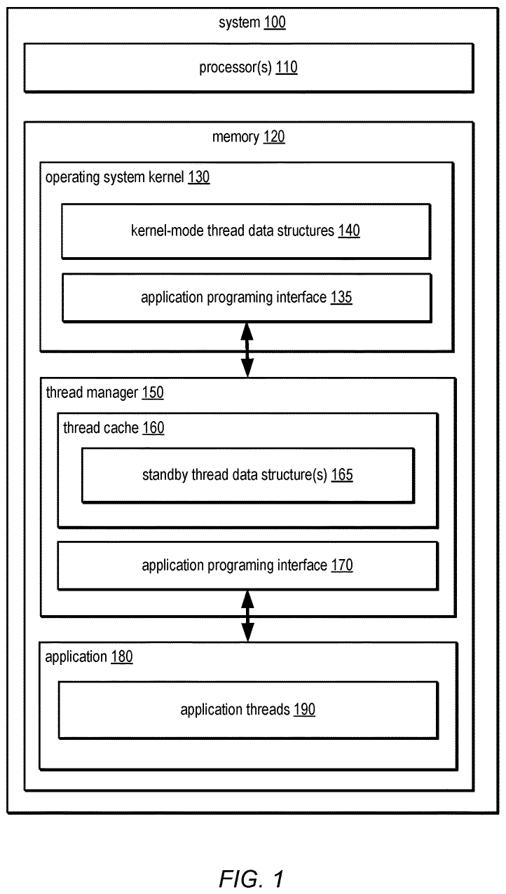

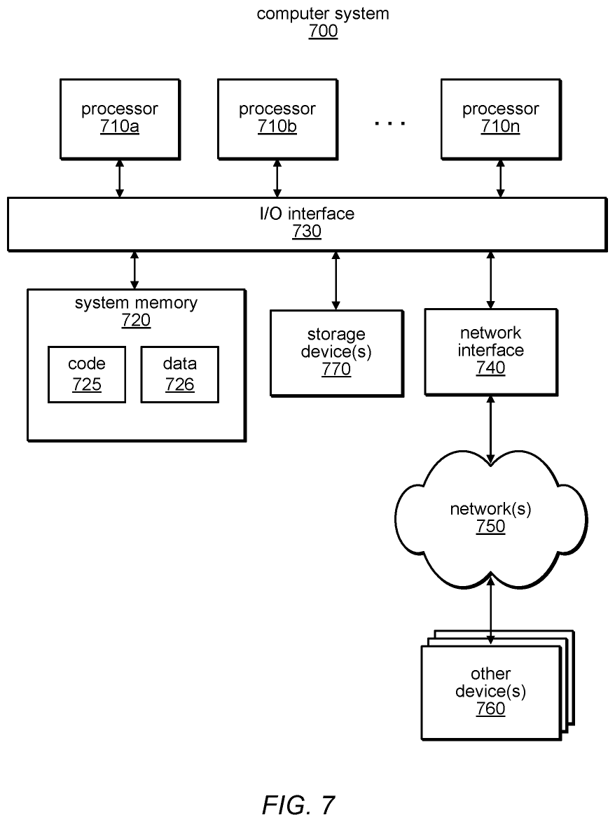

FIG. 1 is a block diagram illustrating a system implementing a thread manager and thread cache for an application in various embodiments. A system 100 includes one or more processors 110 capable of executing multiple parallel threads of execution coupled to a memory 120 that includes an operating system kernel 130, a thread manager 150 and an application 180. An exemplary system 100 is discussed in further detail below in FIG. 7.

Thread manager 150 may include a thread cache 160 and an application programming interface (API) 170 to provide thread management for the application 180. The thread cache 160 of the thread manager 150 may further include a dynamically varying number of standby threads, each including an associated standby thread data structure 165.

The thread manager 150 may interface with an operating system kernel 130 through a separate API 135 to manage threads including the standby threads in the thread cache. Threads created through the API 135 may have associated kernel-mode thread data structures 140 used by the operating system kernel 130 for scheduling and executing individual ones of the threads. The kernel-mode thread data structures 140 may further include thread storage, including thread stacks, as well as memory used to save and restore processor and thread state in various embodiments.

The application 180 may include a dynamically varying number of application threads 190. The application 180 may manage the application threads 190 using the thread manager 150 via the API 170. For example, the application 180 may request, through the API 170, the creation of a thread or the termination of a thread.

The thread manager 150 may implement thread creation in response to a request received via the API 170. In some embodiments, the thread manager may allocate a standby thread from the thread cache 160 to create the requested thread. In the event a standby thread exists, the thread manager 150 may remove the standby thread from the thread cache 160, may initialize data structure(s) 165 of the standby thread, and schedule the thread for execution using the API 135. The standby thread data structure(s) 165 may include thread-local storage and a thread stack, in various embodiments.

The thread cache 160 may be implemented in any number of ways in various embodiments. For example, in some embodiments the thread cache may be implemented as a linked list of standby threads, where the linked list implements a stack, or last-in-first-out (LIFO) list of standby threads. To remove a standby thread from the stack, the thread manager 130 may remove, or “pop”, a thread at the head of the list and update the head of the list to identify the next standby thread in the list. To add a new standby thread to the stack, the thread manager 130 may insert, or “push”, the new standby thread onto the head of the stack. This stack implementation, however, is only one possible embodiment of the thread cache 160 and is not intended to be limiting, as any number of thread cache implementations may be envisioned.

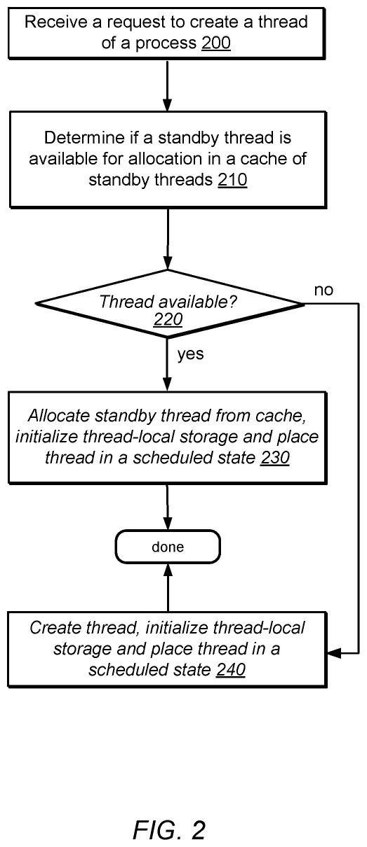

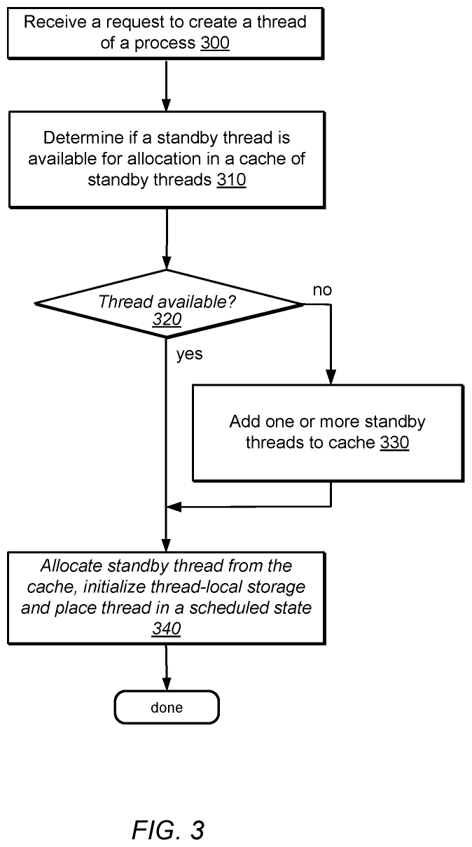

Should no standby thread exist in the thread cache 160, the thread manager 150 may create a thread using the API 135. Once created, the thread manager 150 may add the newly created thread as a standby thread to the thread cache 160, in some embodiments, or it may use the newly created thread to satisfy the thread creation request, in other embodiments. Implementation of thread creation requests is discussed in further detail below in FIGS. 2 and 3.

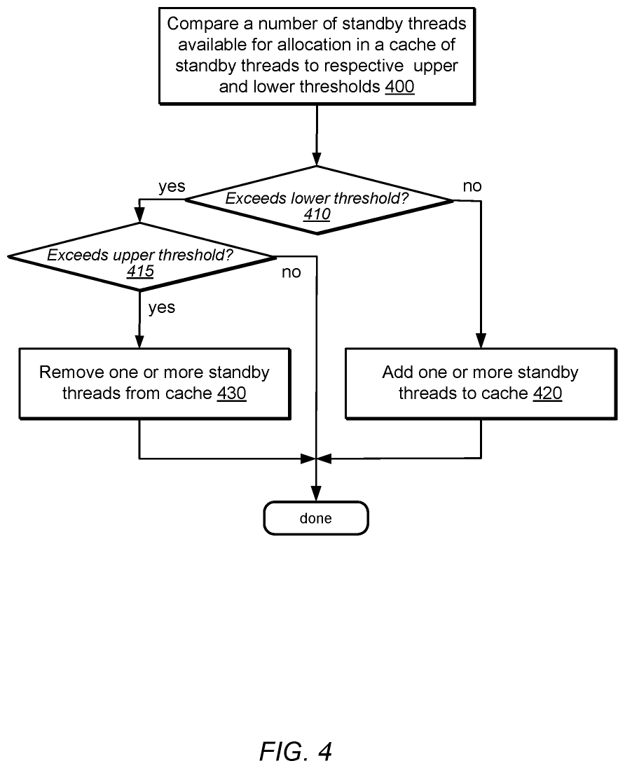

In addition, to improve the likelihood that a standby thread will exist in thread cache 160 when a thread creation request is received, the thread manager 150 may, in some embodiments, monitor the number of standby threads in the thread cache 160. Should the number of standby threads not exceed a lower threshold, the thread manager may create one or more standby thread using the API 135. Once created, the thread manager 150 may then add the newly created standby thread(s) to the thread cache 160. Should the number of standby threads exceed an upper threshold, the thread manager may remove one or more standby thread using the API 135. Further details are discussed below in FIG. 4.

The thread manager may implement thread termination in response to a request received via the API 170. In some embodiments, the thread manager may retain the identified thread in the thread cache rather than destroying the thread through the API 135. To retain the thread, in some embodiments the thread manager 160 may place the thread into a standby, or unscheduled, state using the API 135 and add the thread to the thread cache 160. Retaining the thread in the thread cache may result in the thread-specific data structures, including the data structures 165 and 140, being retained to enable lower latency creation of future threads.

FIG. 2 is a flow diagram illustrating embodiments of a method of creating a thread for an application using a standby thread from a thread cache. The method begins at step 200 where a request to create a thread of an application process may be received, such as via the API 170 as shown in FIG. 1. Once received, the method proceeds to step 210 where a cache maintains standby threads, such as the thread cache 160 as shown in FIG. 1, is checked to determine if a standby thread is available.

If a standby thread is available, as shown in 220, in some embodiments the process may proceed to step 230, where the standby thread is allocated by removing the standby thread from the cache of standby threads, for example by removing a first standby thread from a linked list of available standby threads as discussed above in regard to FIG. 1. The method may then initialize thread-local storage in some embodiments, such as standby thread data structure 165 and kernel-mode thread data structure 140 as shown in FIG. 1, and place the thread in a scheduled state, such as via the API 135 as shown in FIG. 1. The method is then complete.

If, however, a standby thread is not available, as shown in 220, in some embodiments the process may proceed to step 240, where a new thread is created, such as via the API 135 as shown in FIG. 1. The method may then initialize thread-local storage in some embodiments, such as standby thread data structure 165 and kernel-mode thread data structure 140 as shown in FIG. 1, and place the thread in a scheduled state, such as via the API 135 as shown in FIG. 1. The method is then complete.

FIG. 3 is a flow diagram illustrating additional embodiments of a method of creating thread for an application using a standby thread from a thread cache. The method begins at step 300 where a request to create a thread of an application process may be received, such as via the API 170 as shown in FIG. 1. Once received, the method proceeds to step 310 where a cache that maintains standby threads, such as the thread cache 160 as shown in FIG. 1, is checked to determine if a standby thread is available.

If a standby thread is not available, as shown in 320, in some embodiments the process may proceed to step 330, where one or more new threads may be created, such as via the API 135 as shown in FIG. 1. The method may then add these newly created threads to the cache of standby threads, in some embodiments. The method then proceeds to step 340.

If, however, a standby thread is available, as shown in 320, in some embodiments the process may proceed directly to step 340, where a standby thread is allocated by removing the standby thread from the cache of standby threads, for example by removing a first standby thread from a linked list of available standby threads as discussed above in regard to FIG. 1. The method may then initialize thread-local storage in some embodiments, such as standby thread data structure 165 and kernel-mode thread data structure 140 as shown in FIG. 1, and place the thread in a scheduled state, such as via the API 135 as shown in FIG. 1. The method is then complete.

FIG. 4 is a flow diagram illustrating an embodiment of a method for managing standby threads to a thread cache. The method begins at step 400 where a cache that maintains standby threads, such as the thread cache 160 as shown in FIG. 1, is checked to determine if a number of standby threads in the thread cache exceeds upper or lower threshold numbers of standby threads.

If the number of standby threads in the thread cache exceeds a lower threshold number of standby threads, as shown in 410, then the method proceeds to step 415. If the number of standby threads in the thread cache does not exceed an upper threshold number of standby threads, as shown in 415, then the method is complete.

If, however, the number of standby threads in the thread cache does not exceed the lower threshold number of standby threads, as shown in 410, then the method may proceed to step 420 in some embodiments, where one or more new threads may be created, such as via the API 135 as shown in FIG. 1. The method may then add these newly created threads to the thread cache, in some embodiments. The method is then complete.

If the number of standby threads in the thread cache does exceed the upper threshold number of standby threads, as shown in 415, then the method may proceed to step 430 in some embodiments, where one or more threads may be removed from the thread cache and terminated, such as via the API 135 as shown in FIG. 1. The method is then complete.

The upper and lower thresholds may be determined statically or dynamically, in various embodiments. For example, thread creation and termination for the application may be tracked to predict future thread management requests in order to dynamically adjust the number of standby threads in the thread cache using the upper and lower thresholds. Memory usage within the application may also be tracked to determine the upper and lower thresholds and system-wide memory resource usage may also be tracked, alone or in combination with application memory usage, in order to optimize system-wide thread caching as well as intra-process caching. These examples are not intended to be limiting, as any number of methods of determining upper and lower thresholds may be envisioned.

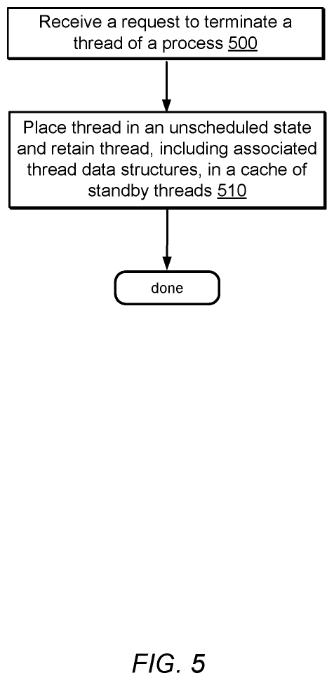

FIG. 5 is a flow diagram illustrating one embodiment of a method for terminating a thread using a thread cache. The method begins at step 500 where a request to terminate a thread of an application process may be received, such as via the API 170 as shown in FIG. 1.

Once received, the method proceeds to step 510, where the thread of the application process is placed in an unscheduled, or standby, state such as via the API 135 as shown in FIG. 1. The method may then add the thread in the standby state to a cache of standby threads, such as the thread cache 160 as shown in FIG. 1. To add the standby thread to the cache of standby threads, the method may, in some embodiments, insert the standby thread at the head of a linked list of available standby threads implementing at least a portion of the cache of standby threads. This linked list, however, is only one possible embodiment and is not intended to be limiting, as any number of standby thread cache implementations may be envisioned. Retaining the thread in the thread cache may result in the thread-specific data structures, including the data structures 165 and 140, being retained to enable lower latency creation of future threads.

In some embodiments, the method may not retain a portion of memory assigned to the standby thread, or the method may alter the configuration of memory assigned to the standby thread in order to allow the operating system kernel, such as the operating system kernel 130 as shown in FIG. 1, to more optimally manage memory resources. These optimizations, however, are not intended to be limiting, as any number of memory management optimizations may be envisioned. Once the standby thread has been added to the cache of standby threads, the method is complete.

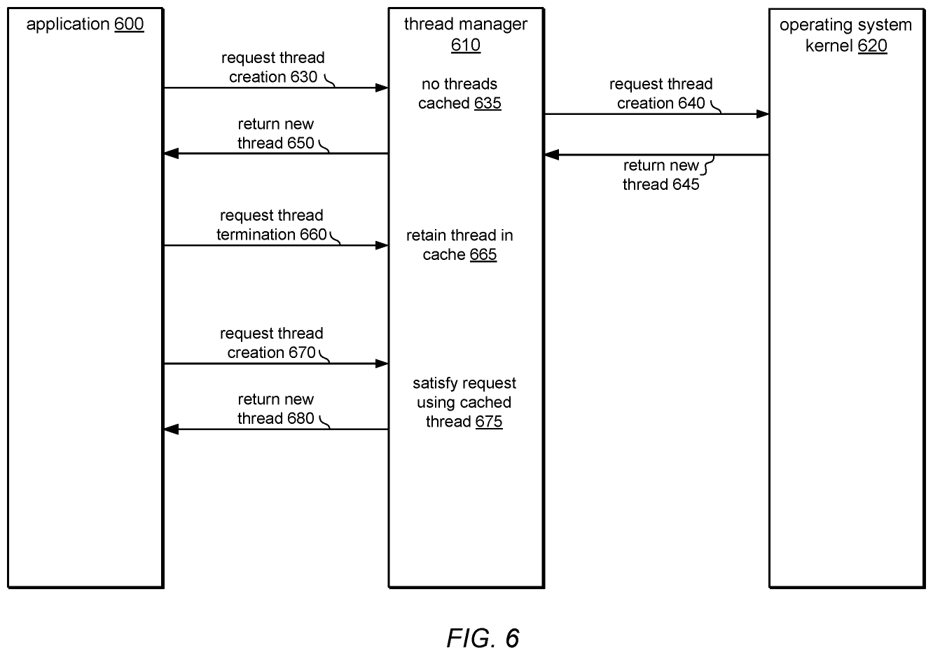

FIG. 6 is a flow diagram illustrating a series of interactions between an application, a thread manager implementing a thread cache, and an operating system kernel, in various embodiments. An application 600, such as the application 180 as shown in FIG. 1, may make a series of thread management requests to a thread manager 610, such as the thread manager 160 as shown in FIG. 1, via a programmatic interface, such as the API 170 as shown in FIG. 1 in some embodiments. The thread manager 610 may additionally make a series of thread management requests to an operating system kernel 620, such as the operating system kernel 130 as shown in FIG. 1, via a programmatic interface, such as the API 135 as shown in FIG. 1 in some embodiments.

The application 600 may make a first request to create a thread for an application process, as shown in 630, to the thread manager 610 in some embodiments. The thread manager 610 may then determine that no standby threads are available in a thread cache, such as the thread cache 160 as shown in FIG. 1. As a result, the thread manager 610 may, in some embodiments, make a request to create a thread to the operating system kernel 620 as shown in 640. The operating system kernel 620 may then, in some embodiments, return a newly created thread, as shown in 645, to the thread manager 610. The thread manager 610 may then, in some embodiments, return the received thread, as shown in 650, to the application 600.

The application 600 may then make a request to terminate a thread of an application process, as shown in 660, to the thread manager 610 in some embodiments. As shown in 665, the thread manager may then, in some embodiments, retain the thread in a standby, unscheduled state, in a thread cache, such as the thread cache 160 as shown in FIG. 1.

The application 600 may make a second request to create a thread for an application process, as shown in 670, to the thread manager 610 in some embodiments. The thread manager 610 may then determine that a standby thread is available in the thread cache and satisfy the second request using the standby thread from the thread cache, as shown in 675. The thread manager 610 may then, in some embodiments, place the standby thread in a scheduled state and return the thread, as shown in 680, to the application 600.

Some of the mechanisms described herein may be provided as a computer program product, or software, that may include a non-transitory, computer-readable storage medium having stored thereon instructions which may be used to program a computer system 600 (or other electronic devices) to perform a process according to various embodiments. A computer-readable storage medium may include any mechanism for storing information in a form (e.g., software, processing application) readable by a machine (e.g., a computer). The machine-readable storage medium may include, but is not limited to, magnetic storage medium (e.g., floppy diskette); optical storage medium (e.g., CD-ROM); magneto-optical storage medium; read only memory (ROM); random access memory (RAM); erasable programmable memory (e.g., EPROM and EEPROM); flash memory; electrical, or other types of medium suitable for storing program instructions. In addition, program instructions may be communicated using optical, acoustical or other form of propagated signal (e.g., carrier waves, infrared signals, digital signals, etc.)

In various embodiments, computer system 700 may include one or more processors 710; each may include multiple cores, any of which may be single- or multi-threaded. For example, multiple processor cores may be included in a single processor chip (e.g., a single processor 710), and multiple processor chips may be included in computer system 700. Each of the processors 710 may include a cache or a hierarchy of caches, in various embodiments. For example, each processor chip 710 may include multiple L1 caches (e.g., one per processor core) and one or more other caches (which may be shared by the processor cores on a single processor). The computer system 700 may also include one or more storage devices 770 (e.g. optical storage, magnetic storage, hard drive, tape drive, solid state memory, etc.) and one or more system memories 710 (e.g., one or more of cache, SRAM, DRAM, RDRAM, EDO RAM, DDR RAM, SDRAM, Rambus RAM, EEPROM, etc.). In some embodiments, one or more of the storage device(s) 770 may be implemented as a module on a memory bus (e.g., on I/O interface 730) that is similar in form and/or function to a single in-line memory module (SIMM) or to a dual in-line memory module (DIMM). Various embodiments may include fewer or additional components not illustrated in FIG. 7 (e.g., video cards, audio cards, additional network interfaces, peripheral devices, a network interface such as an ATM interface, an Ethernet interface, a Frame Relay interface, etc.)

The one or more processors 710, the storage device(s) 770, and the system memory 720 may be coupled to the system interconnect 730. The system memory 720 may contain application data 726 and program code 725. Application data 726 may contain various data structures while program code 725 may be executable to implement one or more applications, shared libraries, and/or operating systems.

Program instructions 725 may be encoded in platform native binary, any interpreted language such as Java′ byte-code, or in any other language such as C/C++, the Java™ programming language, etc., or in any combination thereof. In various embodiments, applications, operating systems, and/or shared libraries may each be implemented in any of various programming languages or methods. For example, in one embodiment, operating system may be based on the Java programming language, while in other embodiments it may be written using the C or C++ programming languages. Similarly, applications may be written using the Java programming language, C, C++, or another programming language, according to various embodiments. Moreover, in some embodiments, applications, operating system, and/shared libraries may not be implemented using the same programming language. For example, applications may be C++ based, while shared libraries may be developed using C.

Although the embodiments above have been described in considerable detail, numerous variations and modifications will become apparent to those skilled in the art once the above disclosure is fully appreciated. For example, although many of the embodiments are described in terms of particular types of operations that support synchronization within multi-threaded applications that access particular shared resources, it should be noted that the techniques and mechanisms disclosed herein for accessing and/or operating on shared resources may be applicable in other contexts in which applications access and/or operate on different types of shared resources than those described in the examples herein. It is intended that the following claims be interpreted to embrace all such variations and modifications.

In conclusion, embodiments providing a thread manager including thread cache are described are disclosed. Applications requesting dynamic thread creation and termination may interact with the thread cache to reduce latency and improve scalability in highly concurrent applications.

What is claimed:

1. A system, comprising:
at least one processor; and
a memory, storing program instructions that when executed by the at least one processor cause the at least one processor to implement a thread manager, the thread manager configured to:
maintain one or more standby threads of a process in an unscheduled state;
receive a request to create a thread of the process; and
responsive to receiving the request, create the thread of the process using a standby thread of the one or more standby threads.

2. The system of claim 1, wherein the one or more standby threads are maintained in a process-local cache of threads of the process.

3. The system of claim 1, wherein to create the thread of the process, the thread manager is configured to place the standby thread in a scheduled state.

4. The system of claim 3, wherein to create the thread of the process the thread manager is further configured to reset data within thread-local storage of the standby thread prior to placing the standby thread in the scheduled state.

5. The system of claim 1, wherein the thread manager is further configured to:
receive a request to terminate another thread of the process;
retain the other thread of the process as another standby thread of the one or more standby threads.

6. The system of claim 5, wherein the other thread comprises a kernel-mode data structure, and wherein retaining the other thread comprises retaining the kernel-mode data structure.

7. A method, comprising:
performing, by one or more computing devices:
maintaining one or more standby threads of a process in an unscheduled state;
receiving a request to create a thread of the process; and
responsive to receiving the request, creating the thread of the process using a standby thread of the one or more standby threads.

8. The method of claim 7, wherein the one or more standby threads are maintained in a process-local cache of threads of the process.

9. The method of claim 7, wherein creating the thread of the process comprises placing the standby thread in a scheduled state.

10. The method of claim 9, wherein creating the thread of the process further comprises resetting data within thread-local storage of the standby thread prior to placing the standby thread in the scheduled state.

11. The method of claim 7, further comprising:
creating, responsive to determining that a number of the one or more standby threads is below a threshold amount, at least one thread for the process in an unscheduled state; and
adding the created standby thread to the one or more standby threads.

12. The method of claim 7, further comprising:
receiving a request to terminate another thread of the process;
retaining the other thread of the process as another standby thread of the one or more standby threads.

13. The method of claim 12, wherein the other thread comprises a kernel-mode data structure, and wherein retaining the other thread comprises retaining the kernel-mode data structure.

14. One or more non-transitory computer-accessible storage media storing program instructions that when executed on or across one or more computing devices cause the one or more computing devices to perform:
maintaining one or more standby threads of a process in an unscheduled state;
receiving a request to create a thread of the process; and
responsive to receiving the request, creating the thread of the process using a standby thread of the one or more standby threads.

15. The one or more non-transitory computer-accessible storage media of claim 14, wherein the one or more standby threads are maintained in a process-local cache of threads of the process.

16. The one or more non-transitory computer-accessible storage media of claim 14, wherein creating the thread of the process comprises placing the standby thread in a scheduled state.

17. The one or more non-transitory computer-accessible storage media of claim 16, wherein creating the thread of the process further comprises resetting data within thread-local storage of the standby thread prior to placing the standby thread in the scheduled state.

18. The one or more non-transitory computer-accessible storage media of claim 14, storing further instructions that when executed on or across the one or more computing devices cause the one or more computing devices to further perform:
creating, responsive to determining that a number of the one or more standby threads is below a threshold amount, at least one thread for the process in an unscheduled state; and
adding the created standby thread to the one or more standby threads.

19. The one or more non-transitory computer-accessible storage media of claim 14, storing further program instructions that when executed on or across one or more computing devices cause the one or more computing devices to further perform:
receiving a request to terminate another thread of the process;
retaining the other thread of the process as another standby thread of the one or more standby threads.

20. The one or more non-transitory computer-accessible storage media of claim 14, wherein the other thread comprises a kernel-mode data structure, and wherein retaining the other thread comprises retaining the kernel-mode data structure.
